(19) United States
(12) Patent Application Publication
(10) Pub. No.: US 2020/0174110 A1
(43) Pub. Date: Jun. 4, 2020

(54) METHODS AND SYSTEMS FOR ULTRA-WIDEBAND (UWB) BASED PLATFORM INTRUSION DETECTION

(71) Applicant: Metrom Rail, LLC, Crystal Lake, IL (US)

(72) Inventors: Richard Carlson, Woodstock, IL (US); Sara Jo Woitel, Lake Zurich, IL (US); Kurt Gunther, Leland, IL (US); John Albert Plutt, JR., Arlington Heights, IL (US)

(21) Appl. No.: 16/667,586

(22) Filed: Oct. 29, 2019

Related U.S. Application Data
(60) Provisional application No. 62/752,162, filed on Oct. 29, 2018.

(51) Int. Cl. G01S 13/02; G01S 13/56; G01S 7/41; G01S 13/88

(52) U.S. Cl. CPC G01S 13/0209; G01S 13/886; G01S 7/411; G01S 13/56

(57) ABSTRACT

Systems and methods are provided for platform intrusion detection. An ultra-wideband (UWB) based platform intrusion detection may include transmitting UWB signals into an area in proximity to a platform, the area that includes one or more tracks; receiving UWB signals within the area; and processing received UWB signals to enable detecting objects within the area. The processing may include identifying received UWB signals corresponding to echoes of the transmitted UWB signal transmitted by the detection devices; detecting based on the echoes of the transmitted UWB signals when an object is present within the area; and assessing the object, wherein assessing the object includes determining when the object represents an intrusion within the area.

### CLAIM OF PRIORITY

This patent application makes reference to, claims priority to, and claims benefit from U.S. Provisional Patent Application Ser. No. 62/752,162, filed on Oct. 29, 2018. The above identified application is incorporated herein by reference in its entirety.

### TECHNICAL FIELD

Aspects of the present disclosure relate to railway control solutions. Various implementations of the present disclosure relate to platform intrusion detection and use thereof with railway systems.

### BACKGROUND

Conventional solutions for handling platform intrusions, if any existed, for controlling braking functions and components in trains may be costly, inefficient, and cumbersome. Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for platform intrusion detection, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1 illustrates an example platform intrusion detection device, in accordance with the present disclosure.

FIG. 2 illustrates an example platform intrusion detection system, in accordance with the present disclosure.

FIG. 3 illustrates an example deployment of platform intrusion detection system, in accordance with the present disclosure.

FIG. 4 illustrates an example deployment of platform intrusion detection system in a platform with existing track infrastructure, in accordance with the present disclosure.

### DETAILED DESCRIPTION

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

Implementations in accordance with the preset disclosure are directed to platform intrusion detection. Platform intrusions affect many railway systems, particularly mass transit systems, with most railway systems experiencing issues with pedestrians being struck and killed by trains at stations. For example, the New York MTA experienced nearly 900 incidents in 2017, in which someone was hit by a train while on the tracks or while being too close on platforms. As the following table (table 1) show, more detailed analysis from prior years (2015 and 2016) shows the consistency of train strikes, and that the majority of incidents occur at stations or platforms.

TABLE 1
platform related accidents in MTA system

| | Struck | Struck | | | | Fell | |
|---|---|---|---|---|---|---|---|
| | Outside | Within | Struck on | Alleged | Attempted | Between | |
| Year | Station | Station | Platform | Suicide | Suicide | Cars | Total |
| 2015 | 15 | 27 | 75 | 21 | 29 | 5 | 172 |
| 2016 | 12 | 31 | 71 | 29 | 22 | 3 | 168 |

Such incidents have significant costs and effects. In addition to the emotional and physical cost to the victim and family of the train strike, many train operators experience ongoing guilt and grief after an incident. Further, emergency personnel and first responders involved with the accident are also affected. These incidents also affect operations. Once a train strike is experienced, the schedule of the train system (or at least the affected line) may be affected at least for the remainder of the day, with inbound and outbound services often are temporarily stopped for an investigation. This results in loss of income for both the rail and riders dependent on the train for transport to work.

Platform intrusion solutions aimed at preventing such incidents exist. For example, platform screen doors are the leading solution for protecting passengers. However, the cost of this solution is prohibitive for most municipalities.

Some platform intrusion detection solutions, aimed at detecting such incidents, also exist but have many challenges. Platform intrusion detection systems face a variety of challenges which make them difficult to use including false positives due to objects, animals, and interference or false negatives when a person is not detected. The table below outlines the technologies and their challenges:

TABLE 2
platform detection technologies and their challenges

| | | | | | | Platform Screen Door | |
|---|---|---|---|---|---|---|---|
| Protection system | | Laser/Infrared | Radar | Weight/Sensor Panel | Video | Full-height | Mid-height |
| Project examples | | Lyon Metro Line D | Budapest | Kuala Lumpur | Programs under | Dubai | Paris Metro |
| | | | Metro | Kelana Jaya Line | development | Metro | Line 1 |
| Interferences | | Snow, Rain, Sun | RF | Heavy Snow, Sand | Light/Sun | Wind | Wind |
| | | | interference | | | | |
| Rolling-stock | | No specific | No specific | No specific | No specific | Doors | Doors |
| | | interference | interference | interference | interference | Synchronization | Synchronization |
| Installation | Duration | Short | Short | Short | Very short | Long | Medium |
| | Location | On top or | Along the | On the tracks | Different spots | On the | On the |
| | | along the | platform and | | on top of the | platform | platform |
| | | tracks of | between double | | tracks | | |
| | | the platform | tracks | | | | |
| | Impact on | No | No | No | No | Yes | Yes |
| | Operations | | | | | | |

| | | | | | | |
|---|---|---|---|---|---|---|
| Curved stations fitting | N/A | N/A | N/A | N/A | Gap between | Gap between |
| | | | | | train and | train and |
| | | | | | PSD | PSD |
| False and non-detection | High, mitigated | Medium | Low | To be assessed | Null | Null |
| | using optimization | | | | | |
| | algorithms | | | | | |
| SIL currently available | SIL2 | SIL1/SIL2 | SIL2 | SIL0 | SIL3 | SIL3 |
| Overall cost | Low | Low | Low | Lowest | High | Medium |

The present disclosure provides solutions for platform intrusion detection, which may overcome at least some challenges of any existing solutions. For example, in various implementations in accordance with the present disclosure, ultra-wideband (UWB) based solutions are used, which provide enhanced detection and/or overcome some of the challenges noted above.

Example train control systems with platform intrusion detection implemented in accordance with the present disclosure may utilize ultra-wideband (UWB) based devices, which are configured to detect (e.g., being configured to operate in radar-like manner) particular objects and/or movements near the platform (particularly on the track or near path of trains), particularly objects and/or movements meeting pre-defined criteria. Use of UWB technology may be particularly suitable for the desired detection functions required for platform intrusion detection.

For example, the extremely wide bandwidth of UWB wireless technology provides several benefits for radar applications. UWB radar using extremely short duration pulses with accompanying wide bandwidth improves the resolution of the radar measurement. The resulting length of the radio wave from a short duration pulse is small compared to detected objects, allowing high resolution detection of the range of the object. This high resolution allows discernment of two objects in close arrangement with each other.

The higher bandwidth signal allows detection of smaller objects or smaller nuances in the shape of those objects. The high bandwidth of UWB also provides superior range measurement resolution, allowing discrimination between signals reflecting off targets located at small differences in range. Further, the high resolution of UWB allows artifacts within the beam width of the radar, such as railroad tracks, signs, wayside signals, support beams, etc. to be ignored.

A scan of the existing items within the UWB radar pattern may be noted as expected (normally present), so only additional “new” objects resulting in reflections of the UWB signal will be considered by the detection algorithm. The extreme bandwidth of UWB provides another significant benefit, namely multipath resistance. The wide bandwidth of UWB provides resilience against multipath cancellation of radio signals so the actual direct path signal and the earliest arriving signal may be detected and processed.

At each passenger station in a rapid transit (or other passenger rail system), the general public must stand in proximity of the railroad track while waiting on the platform for an arriving train to stop for boarding. Some platforms are elevated several feet above the track. If a passenger stumbles or loses his or her balance, the individual may easily fall onto the railroad track. Even if the individual who falls on the tracks is not injured, the person is still in danger. The operator of an oncoming train may not see the person in time to stop the train before collision.

In addition, if the transit system utilizes a “third rail” power distribution architecture, the individual on the tracks is at risk of electrocution due to the 600 VDC to 750 VDC power connected to the elevated third rail alongside the running track. Immediate detection of people on third rail-equipped tracks allows rapid disconnection of power to track. Regardless of whether the intrusion is purposeful or accidental, timely detection of the intrusion is critical in improving safety.

The UWB devices used in systems implemented in accordance with the present disclosure may be configured to detect objects meeting certain pre-configured criteria (e.g., greater than a configurable size) and/or movements associated with such objects meeting certain pre-configured criteria (e.g., small movements, such as breathing). The configurable detection criteria may be adaptively set and/or adjusted to negate false positives

The system (or components thereof) may be configured for adaptive deployment to ensure optimal performance. For example, the radar-like detection unit may be configured for deployment under the platforms, and may be placed at certain distances (e.g., every 20-50 feet) from one another, such as depending on the platform layout, surrounding objects, number of users, etc. Further, the system may have a configurable coverage area (e.g., of 1-3 tracks). The train control system with platform intrusion detection may be configured for reducing the risk of accidents by incorporating various measures for reacting to positive detections.

For example, the system may be configured to react to positive detection by notifying the train operator if an object of a configurable size is located on the covered tracks and/or by stopping the train when an object is detected.

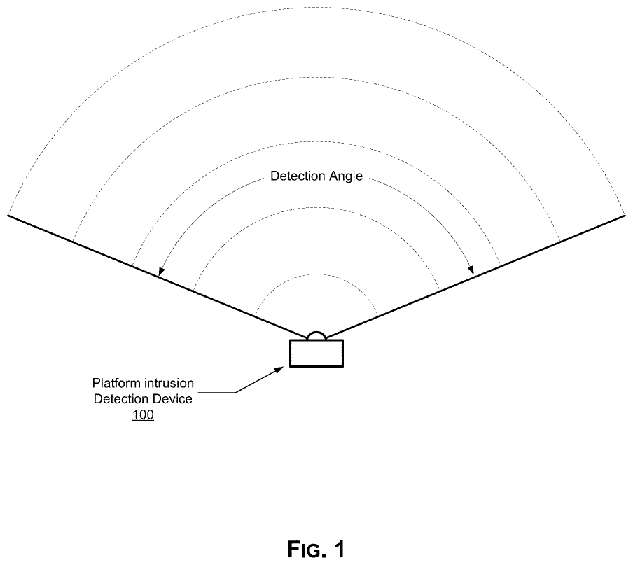

FIG. 1 illustrates an example platform intrusion detection device, in accordance with the present disclosure. Shown in FIG. 1 is a platform intrusion detection device 100 as well as field of view, or detection angle of the device.

The platform intrusion detection device 100 may comprise suitable hardware and related circuitry for performing platform intrusion detection functions in accordance with the present disclose, particularly using UWB technology (e.g., based on transmission, reception, and processing of UWB signals).

As illustrated in FIG. 1, the platform intrusion detection device 100, configured to operate as individual UWB radar sensor, is limited to sensing a particular “field of view”. This field of view may be described by a swept “detection angle” of a maximum distance radius, and has an appearance similar to a large slice of pie, as shown in FIG. 1.

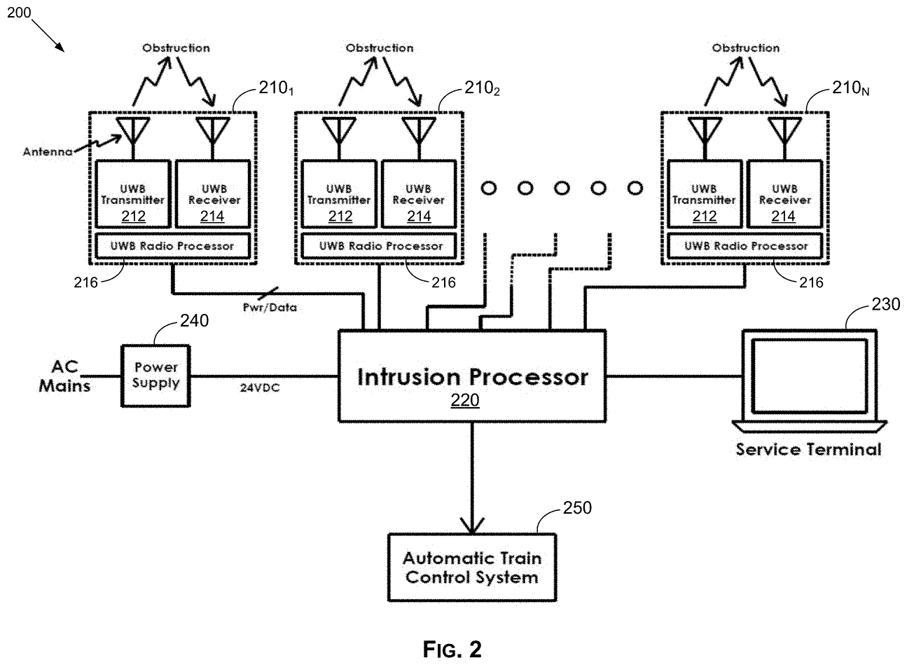

FIG. 2 illustrates an example platform intrusion detection system, in accordance with the present disclosure. Shown in FIG. 2 is a platform intrusion detection system 200, which may be deployed on platforms to provide platform intrusion detection, employing multiple UWB detectors and associated processing resources to discern when an object exceeds the programmed detection threshold.

The platform intrusion detection system 200 may comprise a plurality of platform intrusion detection devices 2101-210N, an intrusion processor 220, a service terminal 230, and a power supply 240.

Each of the platform intrusion detection devices 2101-210N may be similar to, and may represent an implementation of platform intrusion detection device 100 of FIG. 1. For example, as shown in FIG. 2, each may comprise an UWB transmitter 212, an UWB receiver 214, and an UWB processor 216. Each platform intrusion detection device 210 may transmit UWB signals, via the UWB transmitter 212 (and a corresponding antenna), may receive UWB signals, via UWB receiver 214 (and a corresponding antenna), and may process transmitted and/or received UWB signals, via the UWB processor 216. In some implementations, however, a single UWB transceiver may be utilized (instead of separate UWB transmitter and UWB receiver), comprising suitable circuitry for handling both transmission and reception of UWB signals.

The intrusion processor 220 may comprise suitable circuitry that may be configured for controlling the platform intrusion detection devices 2101-210N. For example, the intrusion processor 220 may be configured to process data provided by the platform intrusion detection devices 2101-210N (e.g., based on UWB transmission/reception performed thereby), may provide data to the platform intrusion detection devices 2101-210N (e.g., control data), etc. The intrusion processor 220 may also provide power to the platform intrusion detection devices 2101-210N, such as when these devices lack dedicated power supply. The intrusion processor 220 may manage and control platform intrusion detection operations where the system is deployed.

The service terminal 230 may be configured for allowing operators to interact with, and if needed control operations of the system (e.g., the intrusion processor 220, and if needed, the platform intrusion detection devices 2101-210N, via the intrusion processor 220). The service terminal 230 may also be configured for providing feedback to the operators, such as alerts relating to detected objects.

The power supply 240 may be configured for providing power to the intrusion processor 220 (and thus, if needed, to the platform intrusion detection devices 2101-210N). The power supply 240 may draw power from AC mains available at or near the platform.

Also shown in FIG. 2 is an automatic train control system 250 which may be configured for controlling operations of trains, including automatically—that is, independent of any manual input by any operator of the train. The automatic train control system 250 may be configured to, for example, control such operations as braking. This may enable applying the brakes based on input by the platform intrusion detection system 200, such as when it is determined that an object is in the path of the train (e.g., on the tracks).

In operation, the platform intrusion detection system 200 may be deployed at a platform to provide platform intrusion detection. The platform intrusion detection system 200 may be configured to create a UWB-based sensing area (e.g., adjacent to the platform, and including sections of tracks running in proximity thereto), for detecting objects that may be present (e.g., in the scanned area), and to assess whether any detected object may be pose intrusion in the area (and if so, if it constitutes threat or obstruction to trains running on the tracks).

For example, the platform intrusion detection devices 2101-210N may transmit and receive UWB signals. The received UWB signals may then be processed to provide the object detection. For example, the system (e.g., via the intrusion processor 220) may process received UWB signals (or data obtained based there—e.g., via the UWB processor(s) 216), such as to identify received UWB signals corresponding to echoes of transmitted UWB signals (by platform intrusion detection devices 2101-210N), and to determine, based on processing of received UWB signals (particularly identified echoes of transmitted UWB signals), presence of any objects within coverage area of the platform intrusion detection devices 2101-210N. Once an object is detected, the system (e.g., via the intrusion processor 220) may assess whether the detected object poses an intrusion—e.g., whether it constitute an obstruction to a train running on a section of track with coverage sensing area of the system.

In some instances, various aspects of the detection (and related functions) may be configurable. For example, UWB-based track intrusion detection performed by the system may be configurable with respect to such attributes as size (e.g., a minimum size object that will result in an intrusion detection, range (e.g., only detecting objects within a specified minimum and/or maximum range), etc. In this regard, components of the system may be (re-)configured based on detection related parameters and/or criteria. For example, the transmission and reception range of the platform intrusion detection devices 2101-210N may be adjusted to provide UWB sensing only within the predefined minimum and/or maximum range.

The system may be configured to detect, in addition to detection of mere presence of objects within sensing area of the system, movements of any detected object. In this regard, the system may be configured to detect small movements of a detected object (e.g., chest movement of a human being due to breathing).

The system may also be configured to generate and/or communicate alerts relating to detected objects, particularly objects identified as posing intrusion in the path of trains. In this regard, in some instances the alerts may be configured based on, and/or may contain information relating to details associated with the detected objects (e.g., type of objects, attributes associated thereto, etc.). The alerts may be provided within the system via the service terminal 240. Sometimes, the alerts may be communicated (e.g., wirelessly, such as via UWB signals transmitted by platform intrusion detection devices 2101-210N) generated alerts, such as to approaching trains, to other wayside devices, etc., to alert operators thereof of presence of persons or foreign objects obstructing the track in the protected area (whether it is adjacent to a platform or not).

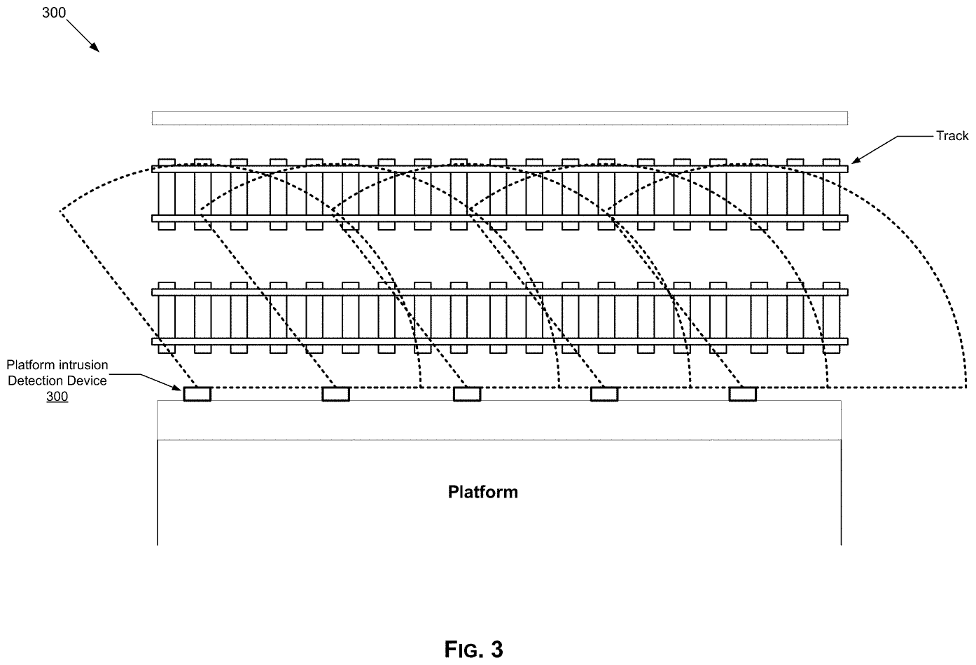

FIG. 3 illustrates an example deployment of platform intrusion detection system, in accordance with the present disclosure. Shown in FIG. 3 is an example platform incorporating an array of platform intrusion detection devices 300, each being similar to the platform intrusion detection device 100 of FIG. 1 and/or the platform intrusion detection devices 2101-210N of FIG. 2. The array of detection devices may be deployed into the platform as part of a platform intrusion detection system, such as the platform intrusion detection system of FIG. 2. In this regard, FIG. 3 illustrates an example deployment of UWB intrusion detectors along a pair of railroad tracks alongside a passenger platform.

The detection devices may be deployed in a manner that provides optimal coverage and detection. For example, as shown in FIG. 3, in order to protect a particular length of track that is prone to intrusion (e.g., section of the track that runs approximately the length of a platform, such as rapid transit station passenger platform), an array of UWB radar transducers and the associated processing electronics may be deployed (e.g., mounted adjacent to, on the edge of, or under the platform) to provide UWB-based sensing (e.g., in radar-like manner) over a predictable length of track, to allow detection of the presence of objects (including individuals and/or physical objects) thereon. The array may consist of individual UWB radar units deployed periodically along the platform, such that there is at least some overlap in the detection pattern of the UWB radar sensors, providing a continuous line of protection along a desired area—e.g., corresponding to track section adjacent to the platform.

In instances where there may be multiple tracks, the array may be configured to provide detection for only one track (e.g., the sensors of that array could be configured to protect only one track), and as such additional arrays may be needed for providing object detection for the remaining tracks (e.g., one dedicated array for each track). Alternatively, a single array be configured to provide detection for several tracks. For example, as shown the particular example implementation illustrated in FIG. 3, the sensors may be deployed such that they provide protection for multiple (e.g., two) adjacent tracks.

The detection function(s) for each device and/or for the array may be adaptively configured to optimize performance. For example, a minimum and/or maximum range may be configured (e.g., via processing resources in each UWB device and/or in a common/central processing system controlling the array as a whole) to enable ignoring objects that meet certain criteria—e.g., objects that are too close or too far away.

For example, to avoid detection of people extending their arm or leg over the platform edge, a preset minimum detection range may be used (e.g., one foot), which may allow the system to avoid a false indication that a person is on the tracks. To avoid detection of people, animals, vehicles or other items further away from tracks, at distances such that there is no obstruction of the track, a maximum sensing distance may be configured so those objects are ignored.

The system (e.g., the array of UWB detectors and/or any accompanying processing resources) may be (re-)configured to accommodate some of these detection criteria. For example, to accommodate false detection prevention (e.g., when people extending their legs or arms from the platform), the array of UWB detectors may be reconfigured to rearrange the detection area (e.g., orientation thereof) to ensure that, such as by rotating it so that it does run along the platform as shown in FIG. 3.

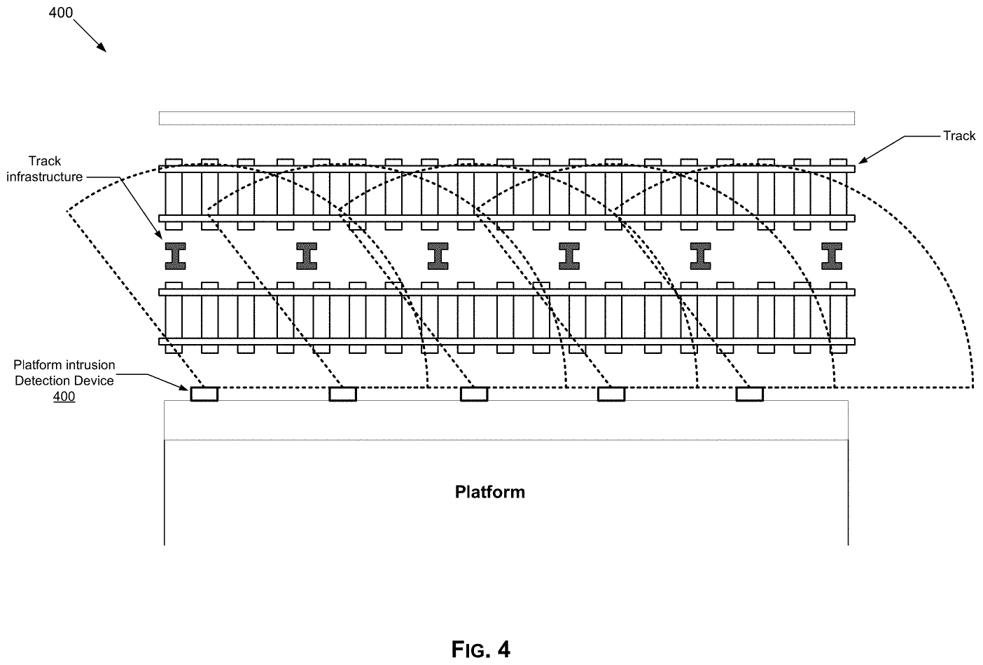

FIG. 4 illustrates an example deployment of platform intrusion detection system in a platform with existing track infrastructure, in accordance with the present disclosure. Shown in FIG. 4 is an example platform incorporating an array of platform intrusion detection devices 400, each being similar to the platform intrusion detection device 100 of FIG. 1 and/or the platform intrusion detection devices 2101-210N of FIG. 2. The array of detection devices may be deployed into the platform as part of a platform intrusion detection system, such as the platform intrusion detection system of FIG. 2. In this regard, FIG. 4 illustrates an example deployment of UWB intrusion detectors along a pair of railroad tracks alongside a passenger platform with existing track infrastructure.

The array of detection devices in FIG. 4 may be configured to operate in the same manner as described above with respect to FIG. 3. However, the array of detection devices (and the corresponding system) in FIG. 4 may also be configured to capture a “baseline” measurement. This baseline measurement would define normal objects in the field of view, such as track infrastructure, which are to be ignored (disregarded as an intrusion).

The system may also be configured to account for the trains. In this regard, when a train moves alongside a platform that is protected by such a system, there will obviously be a significant intrusion detection corresponding to the train itself. Since this is a normal, expected occurrence, and detections of trains as intrusions may result in hundreds of false alerts each day, the system may be configured to account for such detection(s), such as by ignoring such detection(s). There are various techniques for identify and ignoring the presence of a train in a detection zone.

For example, the detection processing system may be interfaced with interlocking train controllers configured to detect when a train is approaching the detection area. The detection capability may be disabled just prior to the train entering the zone, and then re-enabled when the train leaves the zone.

Another technique to prevent false alerts due to train presence along passenger platforms is to configure the detection processor to ignore objects below a minimum distance away from the UWB radar detectors. Because the position of the passenger platform is constructed to minimize the distance between the entry door on the train and the platform surface, a very low minimum detection distance threshold is enough to allow the processor to ignore the presence of a train. For example, in the United States the Americans with Disabilities Act requires transit systems to limit the maximum horizontal gap between the platform edge and the train door sill to no greater than 3 inches (76 mm).

The UWB radar detection processing system may have one or more configurable parameters, such as the number of associated UWB radar sensors, the minimum and/or maximum detection range for each sensor (either individually, or collectively), a minimum object size threshold to trigger a positive detection, how frequently to perform a scan (e.g., >200 milliseconds), and the address of a host system with which to communicate a detection event.

The host system may be configured to sound an alarm in proximity of or near the platform or in a nearby or remote office which may have surveillance video available to allow an operator to inspect the platform area. This would allow a single individual to supervise a number of platforms.

The host system may be configured to communicate a possible detection to a train control system which has the data on which trains are in the vicinity of the platform and will soon approach the platform. This train control system may wireless transmit a caution visual and/or audible indication to the operator of affected train(s). In addition, if desired, the train may be commanded to automatically reduce speed or brake to a complete stop before entering the area of intrusion.

This track intrusion system may be used to not only protect the general public. It may be used to augment worker protection procedures in the event worker(s) are occupying an intrusion-protected section of track on which is a train is traveling.

An example system for platform intrusion detection, in accordance with the present disclosure, comprises one or more detection devices and one or more circuits. Each detection device comprising an ultra-wideband (UWB) based transmitter, configured for transmitting UWB signals, and an ultra-wideband (UWB) based receiver, configured for receiving UWB signals, with the one or more detection devices are configured for transmitting UWB signals into an area in proximity to a platform, the area comprising one or more tracks. The one or more circuits are configured to process received UWB signals, the processing comprising determining received UWB signals corresponding to echoes of transmitted UWB signals transmitted by the one or more detection devices; detect based on the echoes of the transmitted UWB signals when an object is present within the area; and assess the object, wherein assessing the object comprises determining when the object represents an intrusion within the area.

In an example implementation, the one or more circuits are configured to identity a type corresponding to each object.

In an example implementation, the one or more circuits are configured to identity whether the object comprises a person or a physical foreign object.

In an example implementation, the one or more circuits are configured to determine that the object represents an obstruction based on a determination that the object obstructs at least one of the one or more tracks.

In an example implementation, the one or more circuits are configured to generate an alert based on the determination that the object represents an intrusion within the area.

In an example implementation, the one or more circuits are configured to configure or adjust the alert based on parameters or characteristics associated with the object.

In an example implementation, the one or more circuits are configured to wirelessly communicate the alert to one or both: of a train approaching the platform on one of the one or more tracks, and a wayside device disposes on or near one of the one or more tracks.

In an example implementation, the one or more circuits are configured to determine a size of the object, and wherein determining when the object represents an intrusion comprises assessing the size of the objects based on one or more size related parameters for intrusion detection.

In an example implementation, the one or more circuits are configured for detecting objects within a specified minimum and/or maximum range

In an example implementation, the one or more circuits are configured to detect, based on received UWB signals, movement associated with the object.

An example method for platform intrusion detection, in accordance with the present disclosure, comprises transmitting UWB signals into an area in proximity to a platform, the area comprising one or more tracks; receiving UWB signals within the area; processing received UWB signals, the processing comprising determining received UWB signals corresponding to echoes of the transmitted UWB signals; detecting based on the echoes of the transmitted UWB signals when an object is present within the area; and assessing the object, wherein assessing the object comprises determining when the object represents an intrusion within the area.

In an example implementation, the method comprises identifying a type corresponding to each object.

In an example implementation, the method comprises identifying whether the object comprises a person or a physical foreign object.

In an example implementation, the method comprises determining that the object represents an instruction based on a determination that the object obstructs at least one of the one or more tracks.

In an example implementation, the method comprises generating an alert based on the determination that the object represents an intrusion within the area.

In an example implementation, the method comprises configuring or adjusting the alert based on parameters or characteristics associated with the object.

In an example implementation, the method comprises wirelessly communicating the alert to one or both of: a train approaching the platform on one of the one or more tracks, and a wayside device disposes on or near one of the one or more tracks.

In an example implementation, the method comprises determining a size of the object; and determining when the object represents an intrusion based on assessing of the size of the objects based on one or more size related parameters for intrusion detection.

In an example implementation, the method comprises detecting objects within a specified minimum and/or maximum range.

In an example implementation, the method comprises detecting, based on received UWB signals, movement associated with the object.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, causing the machine and/or computer to perform the processes as described herein.

Various embodiments in accordance with the present invention may be realized in hardware, software, or a combination of hardware and software. The present invention may be realized in a centralized fashion in at least one computing system, or in a distributed fashion where different elements are spread across several interconnected computing systems. Any computing system or other apparatus adapted for carrying out the methods described is suited. A typical combination of hardware and software may be a general-purpose computing system with a program or other code that, when being loaded and executed, controls the computing system so it carries out the methods described. Another typical implementation may comprise an application specific integrated circuit or chip.

Various embodiments in accordance with the present invention may also be embedded in a computer program product, which comprises all the features enabling the implementation of the methods described, and which when loaded in a computer system can carry out these methods. Computer program in the present context means any expression, in any language, code or notation, of a set of instructions intended to cause a system having an information processing capability to perform a particular function either directly or after either or both of: a) conversion to another language, code or notation; b) reproduction in a different material form.

While the present invention has been described referring to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system for platform intrusion detection, the system comprising:
one or more detection devices, wherein each detection device comprises:
an ultra-wideband (UWB) based transmitter, configured for transmitting UWB signals; and
an ultra-wideband (UWB) based receiver, configured for receiving UWB signals; and
wherein the one or more detection devices are configured for transmitting UWB signals into an area in proximity to a platform, the area comprising one or more tracks; and
one or more circuits configured to:
process received UWB signals, the processing comprising determining received UWB signals corresponding to echoes of transmitted UWB signals transmitted by the one or more detection devices;
detect based on the echoes of the transmitted UWB signals when an object is present within the area; and
assess the object, wherein assessing the object comprises determining when the object represents an intrusion within the area.

2. The system of claim 1, wherein the one or more circuits are configured to identity a type corresponding to each object.

3. The system of claim 2, wherein the one or more circuits are configured to identity whether the object comprises a person or a physical foreign object.

4. The system of claim 1, wherein the one or more circuits are configured to determine that the object represents an obstruction based on a determination that the object obstructs at least one of the one or more tracks.

5. The system of claim 1, wherein the one or more circuits are configured to generate an alert based on the determination that the object represents an intrusion within the area.

6. The system of claim 5, wherein the one or more circuits are configured to configure or adjust the alert based on parameters or characteristics associated with the object.

7. The system of claim 5, wherein the one or more circuits are configured to wirelessly communicate the alert to one or both: of a train approaching the platform on one of the one or more tracks, and a wayside device disposes on or near one of the one or more tracks.

8. The system of claim 1, wherein the one or more circuits are configured to determine a size of the object, and wherein determining when the object represents an intrusion comprises assessing the size of the objects based on one or more size related parameters for intrusion detection.

9. The system of claim 1, wherein the one or more circuits are configured for detecting objects within a specified minimum and/or maximum range.

10. The system of claim 1, wherein the one or more circuits are configured to detect, based on received UWB signals, movement associated with the object.

11. A method for platform intrusion detection, the method comprising:
transmitting UWB signals into an area in proximity to a platform, the area comprising one or more tracks;
receiving UWB signals within the area;
processing received UWB signals, the processing comprising determining received UWB signals corresponding to echoes of the transmitted UWB signals;
detecting based on the echoes of the transmitted UWB signals when an object is present within the area; and
assessing the object, wherein assessing the object comprises determining when the object represents an intrusion within the area.

12. The method of claim 11, further comprising identifying a type corresponding to each object.

13. The method of claim 12, further comprising identifying whether the object comprises a person or a physical foreign object.

14. The method of claim 11, further comprising determining that the object represents an instruction based on a determination that the object obstructs at least one of the one or more tracks.

15. The method of claim 11, further comprising generating an alert based on the determination that the object represents an intrusion within the area.

16. The method of claim 15, further comprising configuring or adjusting the alert based on parameters or characteristics associated with the object.

17. The method of claim 15, further comprising wirelessly communicating the alert to one or both of: a train approaching the platform on one of the one or more tracks, and a wayside device disposes on or near one of the one or more tracks.

18. The method of claim 11, further comprising:
determining a size of the object; and
determining when the object represents an intrusion based on assessing of the size of the objects based on one or more size related parameters for intrusion detection.

19. The method of claim 11, further comprising detecting objects within a specified minimum and/or maximum range.

20. The method of claim 11, further comprising detecting, based on received UWB signals, movement associated with the object.
